(19) United States
(12) Patent Application Publication
(10) Pub. No.: US 2016/0069297 A1
(43) Pub. Date: Mar. 10, 2016

(54) GEARED TURBINE ENGINE WITH O-DUCT AND THRUST REVERSER

(71) Applicant: UNITED TECHNOLOGIES CORPORATION, Hartford, CT (US)

(72) Inventor: Nigel D. Sawyers-Abbott, South Glastonbury, CT (US)

(73) Assignee: United Technoligies Corporation, Hartford, CT (US)

(21) Appl. No.: 14/786,439

(22) PCT Filed: Apr. 24, 2014
(86) PCT No.: PCT/US14/35300

§ 371 Date: Oct. 22, 2015

Related U.S. Application Data
(60) Provisional application No. 61/815,570, filed on Apr. 24, 2013.

(51) Int. Cl. F02K 1/72; F02C 3/107; F02C 7/36

(52) U.S. Cl. CPC F02K 1/72; F02C 7/36; F02C 3/107; F05D 2220/32; F05D 2260/4031

(57) ABSTRACT

A geared turbofan engine is provided that includes a first rotor, a second rotor and a gear train that are arranged along an axis within a casing. The first rotor is connected to and driven by the second rotor through the gear train. The casing includes a nozzle, a bifurcation, a thrust reverser and a flowpath. The flowpath extends axially to the nozzle and circumferentially between opposing surfaces of the bifurcation.

This application claims priority to U.S. Patent Appln. No. 61/815,570 filed Apr. 24, 2013.

### BACKGROUND OF THE INVENTION

1. Technical Field

This disclosure relates generally to a geared turbine engine and, more particularly, to a geared turbine engine with a thrust reverser.

2. Background Information

Various types and configurations of turbine engines and thrust reversers for turbine engines are known in the art. There is a need, however, for an improved turbine engine and thrust reverser.

### SUMMARY OF THE DISCLOSURE

According to an aspect of the invention, a geared turbofan engine is provided that includes a first rotor, a second rotor, a gear train and a casing. The first rotor, second rotor and gear train are arranged along an axis within the casing. The first rotor is connected to and driven by the second rotor through the gear train. The casing includes a nozzle, a bifurcation, a thrust reverser and a flowpath. The flowpath extends axially to the nozzle and circumferentially between opposing surfaces of the bifurcation.

According to another aspect of the invention, a geared turbine engine is provided that includes a gear train connected to a first rotor and a second rotor along an axis. The geared turbine engine also includes a casing that houses the gear train, the first rotor and the second rotor. The casing includes a nozzle, an O-duct and a thrust reverser with a flow area that is greater than a flow area of the nozzle. The O-duct includes an aft cowling that translates along the axis.

According to still another aspect of the invention, a turbine engine system is provided that includes a geared turbofan engine and an engine support structure. The geared turbofan engine includes an axis and a casing that is connected to the engine support structure. The casing includes a nozzle, a bifurcation, a thrust reverser and a bypass flowpath. The thrust reverser having a flow area that is greater than a flow area of the nozzle. The bypass flowpath extends axially to the nozzle, and circumferentially between opposing surfaces of the bifurcation.

The geared turbofan engine may include a first rotor, a second rotor and a gear train that are arranged along the axis within the casing. The first rotor may be connected to and driven by the second rotor through the gear train.

The engine support may be configured as or otherwise be included with an engine pylon.

The O-duct may include a nozzle, a bifurcation and a flowpath. The flowpath may extend axially to the nozzle and/or circumferentially between opposing surfaces of the bifurcation.

The thrust reverser may have a flow area that is greater than a flow area of the nozzle. For example, the flow area of the thrust reverser may be greater than or equal to about one hundred and ten percent (110%) of the flow area of the nozzle.

The engine may include a plurality of engine sections that provide forward engine thrust. A first of the engine sections may include the first rotor. A second of the engine sections may include the second rotor. The thrust reverser may provide reverse engine thrust, which may be greater than or equal to about one fifth (⅕ or 20%) of the forward engine thrust.

The first rotor may be configured as or otherwise include a fan rotor. Alternatively, the first rotor may be configured as or otherwise include a compressor rotor, or any other engine rotor. The second rotor may be configured as or otherwise include a turbine rotor, or any other engine rotor.

The gear train may be configured as or otherwise include an epicyclic transmission.

The casing may include a core nacelle and a fan nacelle. The flowpath may extend radially between an outer surface of the core nacelle and an inner surface of the fan nacelle.

The fan nacelle may include an aft cowling (e.g., a translating sleeve) that axially translates along a support structure, which may be circumferentially aligned with the bifurcation. In addition, the core nacelle may include an aft cowling (e.g., a translating sleeve) that axially translates with the aft cowling of the fan nacelle.

The flowpath may extend more than about 5.6 radians around the axis between the opposing surfaces of the bifurcation.

The thrust reverser may include a plurality of turning vanes arranged within an axially fixed cascade. The thrust reverser may also or alternatively include a plurality of turning vanes arranged within a cascade that translates along the axis.

The thrust reverser may include a cascade and a blocker door. The blocker door may pivot (e.g., radially inwards) into the flowpath and divert gas through the cascade.

The thrust reverser may include a cascade and a thrust reverser body. The thrust reverser body may translate along the axis to at least partially obstruct the flowpath and divert gas through the cascade.

The casing may include a body that defines the nozzle. This body may move axially and/or radially to change a flow area of the nozzle.

The foregoing features and the operation of the invention will become more apparent in light of the following description and the accompanying drawings.

### BRIEF DESCRIPTION OF THE DRAWINGS

FIG. 1 is a side cutaway illustration of a geared turbofan engine;

FIG. 2 is a side cutaway illustration of an engine casing for the geared turbofan engine in a first configuration;

FIG. 3 is a side cutaway illustration of the engine casing of FIG. 2 in a second configuration;

FIG. 4 is a cross-sectional schematic illustration of the engine casing of FIG. 2;

FIG. 5 is a partial side cutaway illustration of a thrust reverser and a variable area nozzle in stowed positions;

FIG. 6 is a partial side cutaway illustration of the thrust reverser of FIG. 5 in the stowed position and the variable area nozzle of FIG. 5 in a deployed position;

FIG. 7 is a partial side cutaway illustration of the thrust reverser and the variable area nozzle of FIG. 5 in deployed positions;

FIG. 8 is a partial side sectional illustration of an alternate embodiment thrust reverser in a stowed position;

FIG. 9 is a partial side sectional illustration of the thrust reverser of FIG. 8 in a deployed position;

FIG. 10 is a partial side schematic illustration of an alternate embodiment variable area nozzle in a stowed position;

FIG. 11 is a partial side schematic illustration of the variable area nozzle of FIG. 10 in a deployed position;

FIG. 12 is a side cutaway illustration of another engine casing for the geared turbofan engine in a first configuration;

FIG. 13 is a side cutaway illustration of the engine casing of FIG. 12 in a second configuration; and

FIG. 14 is a side cutaway illustration of an alternate embodiment geared turbofan engine.

### DETAILED DESCRIPTION OF THE INVENTION

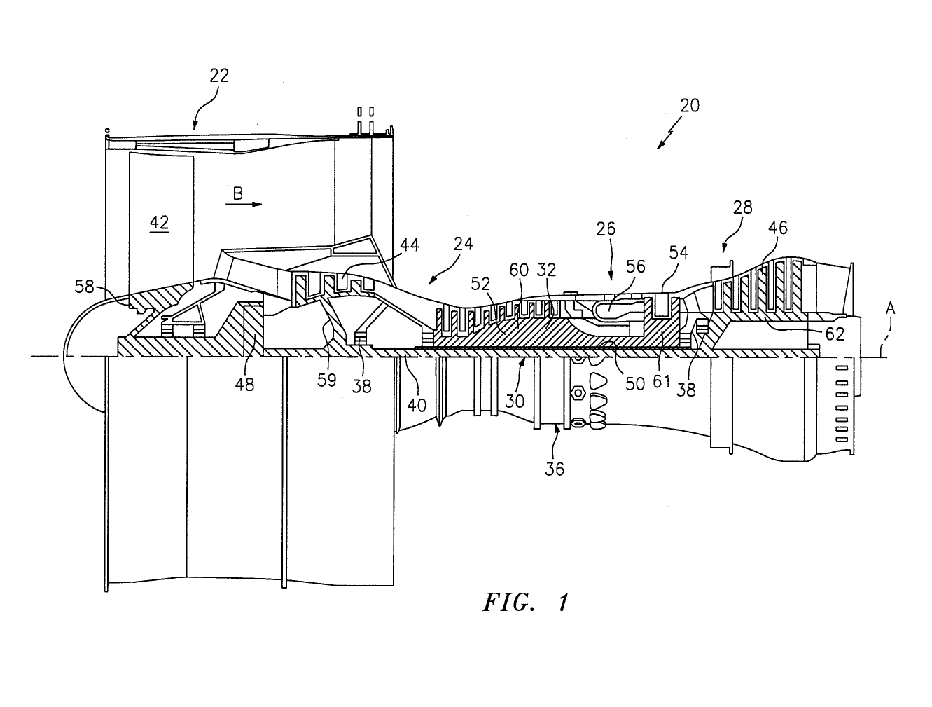

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath while the compressor section 24 drives air along a core flowpath for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines such as a three-spool (plus fan) engine wherein an intermediate spool includes an intermediate pressure compressor (IPC) between the LPC and HPC and an intermediate pressure turbine (IPT) between the HPT and LPT.

The engine 20 generally includes a low spool 30 and a high spool 32 mounted for rotation about an engine central longitudinal axis A relative to an engine static structure 36 via several bearing structures 38. The low spool 30 generally includes an inner shaft 40 that interconnects a fan 42, a low pressure compressor 44 (“LPC”) and a low pressure turbine 46 (“LPT”). The inner shaft 40 drives the fan 42 through a geared architecture 48 to drive the fan 42 at a lower speed than the low spool 30. An exemplary reduction transmission is an epicyclic transmission, namely a planetary or star gear system.

The high spool 32 includes an outer shaft 50 that interconnects a high pressure compressor 52 (“HPC”) and high pressure turbine 54 (“HPT”). A combustor 56 is arranged between the high pressure compressor 52 and the high pressure turbine 54. The inner shaft 40 and the outer shaft 50 are concentric and rotate about the engine central longitudinal axis A which is collinear with their longitudinal axes.

Core airflow is compressed by the low pressure compressor 44 then the high pressure compressor 52, mixed with the fuel and burned in the combustor 56, then expanded over the high pressure turbine 54 and low pressure turbine 46. The turbines 54, 46 rotationally drive the respective low spool 30 and high spool 32 in response to the expansion.

The main engine shafts 40, 50 are supported at a plurality of points by the bearing structures 38 within the static structure 36. It should be understood that various bearing structures 38 at various locations may alternatively or additionally be provided.

In one non-limiting example, the gas turbine engine 20 is a high-bypass geared aircraft engine. In a further example, the gas turbine engine 20 bypass ratio is greater than about six (6:1). The geared architecture 48 can include an epicyclic gear train, such as a planetary gear system or other gear system. The example epicyclic gear train has a gear reduction ratio of greater than about 2.3, and in another example is greater than about 2.5:1. The geared turbofan enables operation of the low spool 30 at higher speeds which can increase the operational efficiency of the low pressure compressor 44 and low pressure turbine 46 and render increased pressure in a fewer number of stages.

A pressure ratio associated with the low pressure turbine 46 is pressure measured prior to the inlet of the low pressure turbine 46 as related to the pressure at the outlet of the low pressure turbine 46 prior to a core nozzle of the gas turbine engine 20. In one non-limiting embodiment, the bypass ratio of the gas turbine engine 20 is greater than about ten (10:1), the fan diameter is significantly larger than that of the low pressure compressor 44, and the low pressure turbine 46 has a pressure ratio that is greater than about 5 (5:1). It should be understood, however, that the above parameters are only exemplary of one embodiment of a geared architecture engine and that the present disclosure is applicable to other gas turbine engines including direct drive turbofans.

In one embodiment, a significant amount of thrust is provided by the bypass flowpath B due to the high bypass ratio. The fan section 22 of the gas turbine engine 20 may be designed for a particular flight condition—typically cruise at about 0.8 Mach and about 35,000 feet. This flight condition, with the gas turbine engine 20 at its best fuel consumption, is also known as bucket cruise Thrust Specific Fuel Consumption (TSFC). TSFC is an industry standard parameter of fuel consumption per unit of thrust.

Fan Pressure Ratio is the pressure ratio across a blade of the fan section 22 without the use of a Fan Exit Guide Vane system. The low Fan Pressure Ratio according to one non-limiting embodiment of the example gas turbine engine 20 is less than 1.45. Low Corrected Fan Tip Speed is the actual fan tip speed divided by an industry standard temperature correction of “T”/518.7^{0.5} in which “T” represents the ambient temperature in degrees Rankine. The Low Corrected Fan Tip Speed according to one non-limiting embodiment of the example gas turbine engine 20 is less than about 1150 fps (351 m/s).

Referring still to FIG. 1, the fan section 22 includes a fan rotor 58. The compressor section 24 includes a low pressure compressor (LPC) rotor 59 and a high pressure compressor (HPC) rotor 60. The turbine section 28 includes a high pressure turbine (HPT) rotor 61 and a low pressure turbine (LPT) rotor 62. Each of these rotors 58-62 includes a plurality of rotor blades arranged circumferentially around and connected to (e.g., formed integral with or attached to) one or more respective rotor disks. The fan rotor 58 is connected to the geared architecture 48. The geared architecture 48 and the LPC rotor 59 are connected to and driven by the LPT rotor 62 through the inner shaft 40. The HPC rotor 60 is connected to and driven by the HPT rotor 61 through the outer shaft 50.

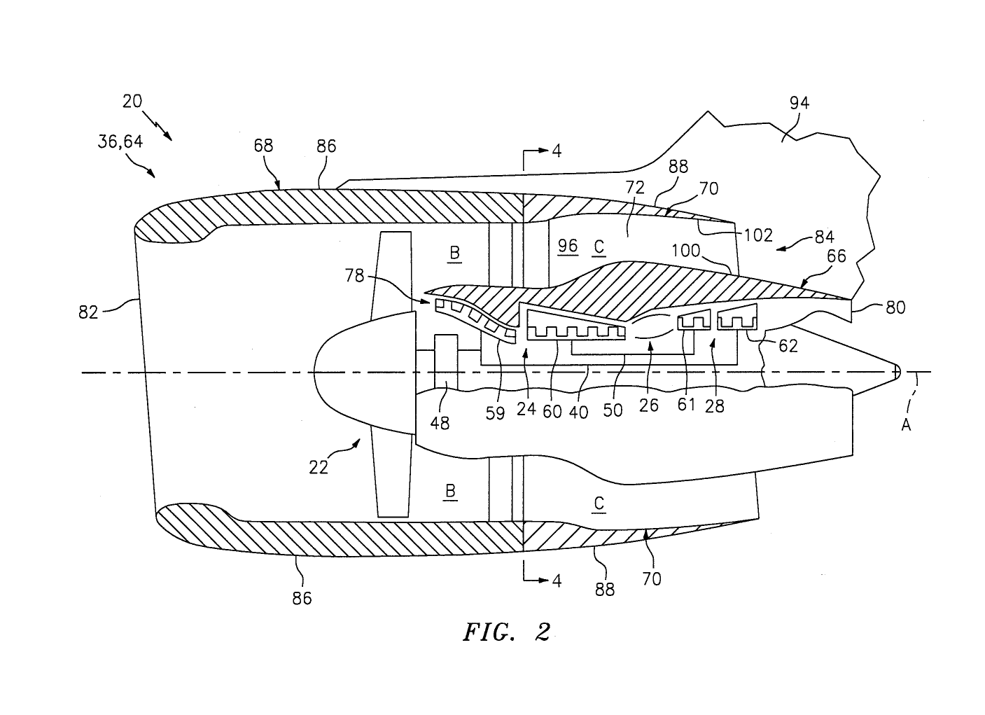

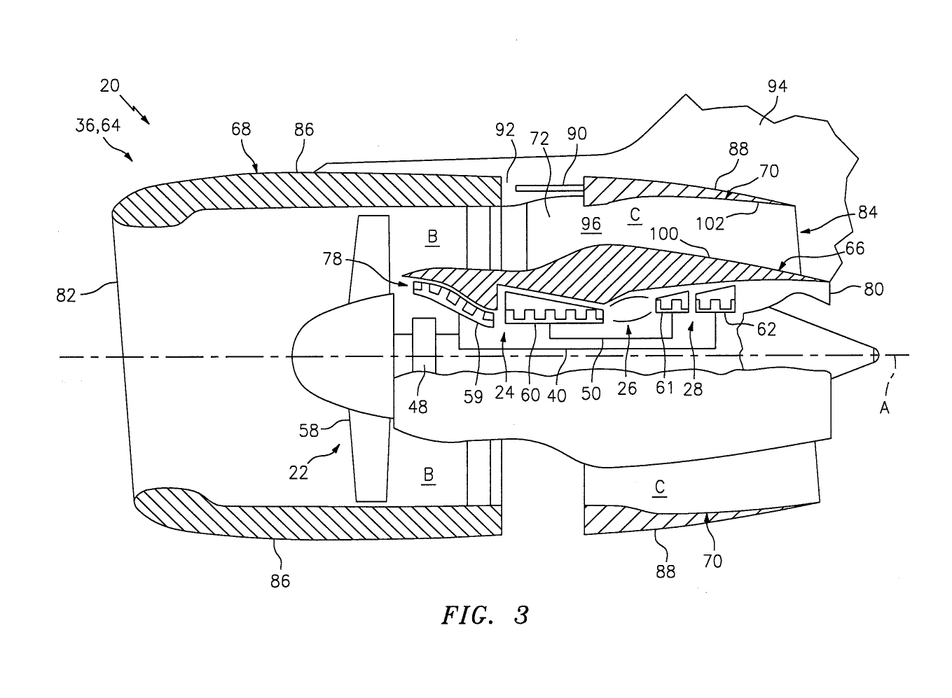

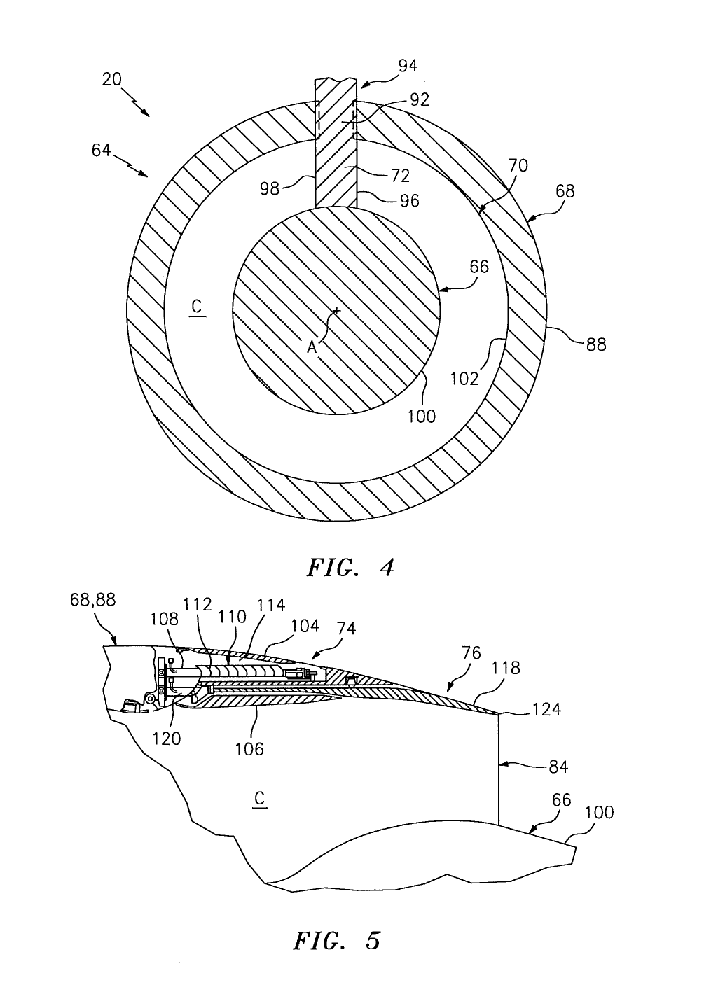

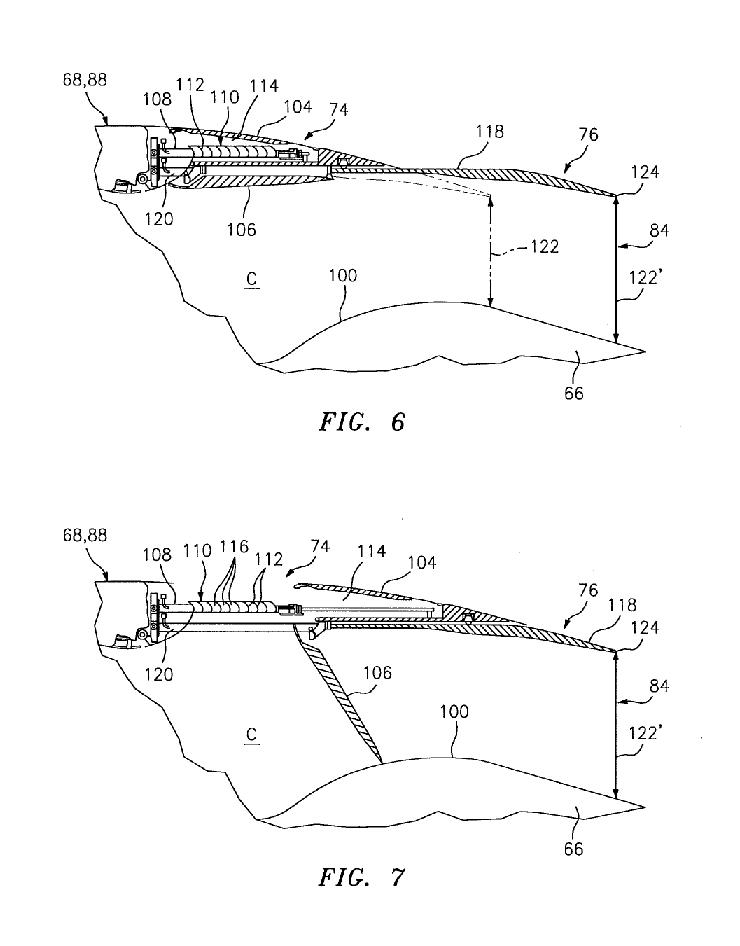

Referring to FIGS. 2 and 3, the engine static structure 36 includes an engine casing 64 that houses the engine sections 22, 24, 26 and 28 and the geared architecture 48. The engine casing 64 includes a core nacelle 66, a fan nacelle 68, a duct 70 and a bifurcation 72 (see also FIG. 4). Referring to FIGS. 5 to 6, the engine casing 64 also includes at least one thrust reverser 74 and a variable area nozzle (VAN) 76; e.g., a variable area fan nozzle (VAFN).

Referring to FIGS. 2 and 3, the core nacelle 66 extends circumferentially around and houses the rotors 59-62. The core nacelle 66 may also extend circumferentially around and house the geared architecture 48. The core nacelle 66 extends axially along the longitudinal axis

A between an inlet 78 of the core flowpath (“core inlet”) and a nozzle 80 of the core flowpath (“core nozzle”).

The fan nacelle 68 extends circumferentially around and houses the fan rotor 58. The fan nacelle 68 also extends circumferentially around and houses at least a portion of the core nacelle 66, thereby defining the bypass flowpath B. The fan nacelle 68 extends axially along the longitudinal axis A between an airflow inlet 82 of the engine 20 and a nozzle 84 of the bypass flowpath B (“bypass nozzle”). The fan nacelle 68 includes a stationary forward portion 86 and an aft cowling 88; e.g., a translating sleeve. The aft cowling 88 is adapted to translate axially along a plurality of tracks 90 (see FIG. 3). These tracks 90 are connected to opposing sides of an engine support structure 92, which may be configured as part of an engine pylon 94 that mounts the turbine engine 20 to an aircraft airframe; e.g., an aircraft wing or fuselage.

The bifurcation 72 may be referred to as an upper bifurcation. The bifurcation 72, however, is not limited to any particular spatial orientations. For example, while the bifurcation 72 is illustrated in the drawings as being located within a gravitational top portion of the duct 70, it may alternatively be located within a gravitational side or bottom portion of the duct 70.

The bifurcation 72 extends radially between the core nacelle 66 and the fan nacelle 68 through the bypass flowpath B, thereby bifurcating the bypass flowpath B. Referring to FIGS. 3 and 4, the bifurcation 72 is circumferentially aligned with and at least partially houses the support structure 92.

The duct 70 includes at least a portion of the core nacelle 66, the aft cowling 88 and the bifurcation 72. The duct 70 is configured as an O-duct, and defines at least an aft portion C of the bypass flowpath (“aft flowpath portion”). This aft flowpath portion C may be substantially uninterrupted by bifurcation(s) and/or support structure(s) other than the bifurcation 72 and the support structure 92. The aft flowpath portion C, for example, may extend substantially uninterrupted at least about 5.6-5.9 radians (that is, about 320-338 degrees) around the longitudinal axis A between opposing surfaces 96 and 98 of the bifurcation 72 as measured, for example, at a widest portion of the bifurcation 72 within the duct 70. Circumferential bounds of the aft flowpath portion C, however, are not limited to the example provided above. The aft flowpath portion C extends axially within the engine casing 64 to the bypass nozzle 84. The aft flowpath portion C extends radially between a radial outer surface 100 of the core nacelle 66 and a radial inner surface 102 of the aft cowling 88.

FIG. 5 illustrates the thrust reverser 74 and the variable area nozzle 76 in stowed positions. FIG. 6 illustrates the thrust reverser 74 in the stowed position and the variable area nozzle 76 in a deployed position. FIG. 7 illustrates the thrust reverser 74 and the variable area nozzle 76 in deployed positions. Referring to FIGS. 5 to 7, the thrust reverser 74 includes at least one thrust reverser body 104, which is configured with the aft cowling 88. The thrust reverser 74 also includes one or more blocker doors 106, one or more actuators 108, and one or more cascades 110 of turning vanes 112. These blocker doors 106, actuators 108 and cascades 110 are respectively arranged circumferentially around the longitudinal axis A.

The thrust reverser body 104 may have a generally tubular geometry with an axially extending slot or channel configured to accommodate the support structure 92 of FIG. 3. The thrust reverser body 104 includes at least one recess 114 that houses the cascades 110 and the actuators 108 when the thrust reverser 74 is in the stowed position. Each blocker door 106 is pivotally connected to the thrust reverser body 104. The actuators 108 are adapted to axially translate the thrust reverser body 104 between the stowed position of FIGS. 5 and 6 and the deployed position of FIG. 7. As the thrust reverser body 104 translates aftwards, the blocker doors 106 pivot radially inward into the aft flowpath portion C and divert at least some or substantially all of the bypass air through the cascades 110 to provide the reverse engine thrust. This reverse engine thrust may be equal to or greater than about one fifth (e.g., twenty percent) of the forward engine thrust. The thrust reverser 74 therefore provides a relatively high mass flow reversing system as compared to prior art systems.

In the deployed position of FIG. 7, the thrust reverser 74 has an effective flow area. This effective flow area describes a collective cross-sectional area of flowpaths through and/or around the thrust reverser 74. These flowpaths include flowpaths 116 through each cascade 110 that are respectively defined between the turning vanes 112. The flowpaths may also include one or more leakage and/or control gaps through which the bypass air may flow around the blocker doors 106 and/or the cascades 110.

Referring to FIGS. 5 and 6, the variable area nozzle 76 includes a nozzle body 118 and one or more actuators 120. The nozzle body 118 is configured with the aft cowling 88, and arranged radially within and may nest with the thrust reverser body 104. The nozzle body 118 may have a generally tubular geometry with an axially extending slot or channel configured to accommodate the support structure 92 of FIG. 3. The actuators 120 are adapted to axially translate the nozzle body 118 between the stowed position of FIG. 5 and the deployed position of FIG. 6. As the nozzle body 118 translates aftwards, a radial height 122 of the bypass nozzle 84 between an aft end 124 of the fan nacelle 68 and the core nacelle 66 may change (e.g., increase) and thereby change (e.g., increase) a flow area of the bypass nozzle 84; e.g., the height 122′ may be greater than the height 122. In this manner, the variable area nozzle 76 may adjust pressure drop across the bypass flowpath B (see FIGS. 2 and 3) by changing the flow area of the bypass nozzle 84.

The flow area of the bypass nozzle 84 describes a cross-sectional area of the bypass nozzle 84. Referring to FIGS. 6 and 7, the flow area of the bypass nozzle 84 may be less than or equal to the flow area of the thrust reverser 74. The flow area of the thrust reverser 74, for example, may be equal to or greater than about one hundred and ten percent (e.g., 110%) of the flow area of the bypass nozzle 84, where the thrust reverser 74 is in the stowed position of FIG. 5 or 6. This relatively high flow area of the thrust reverser 74 is enabled by, for example, the relatively low fan pressure ratio of the engine 20. The relatively high flow area may also enable the thrust reverser 74 to provide the high mass flow reversing system described above.

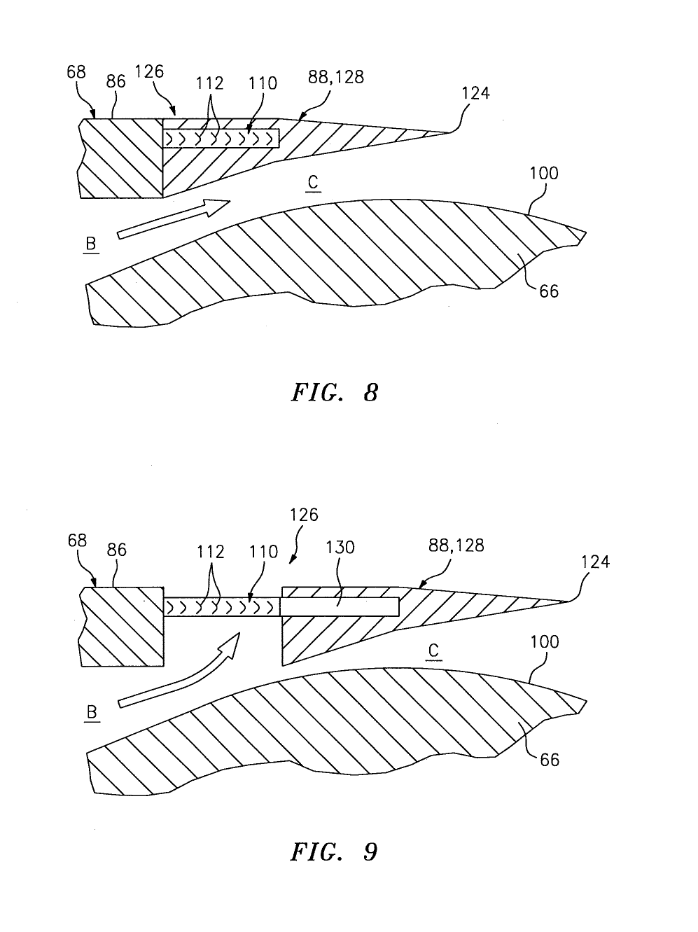

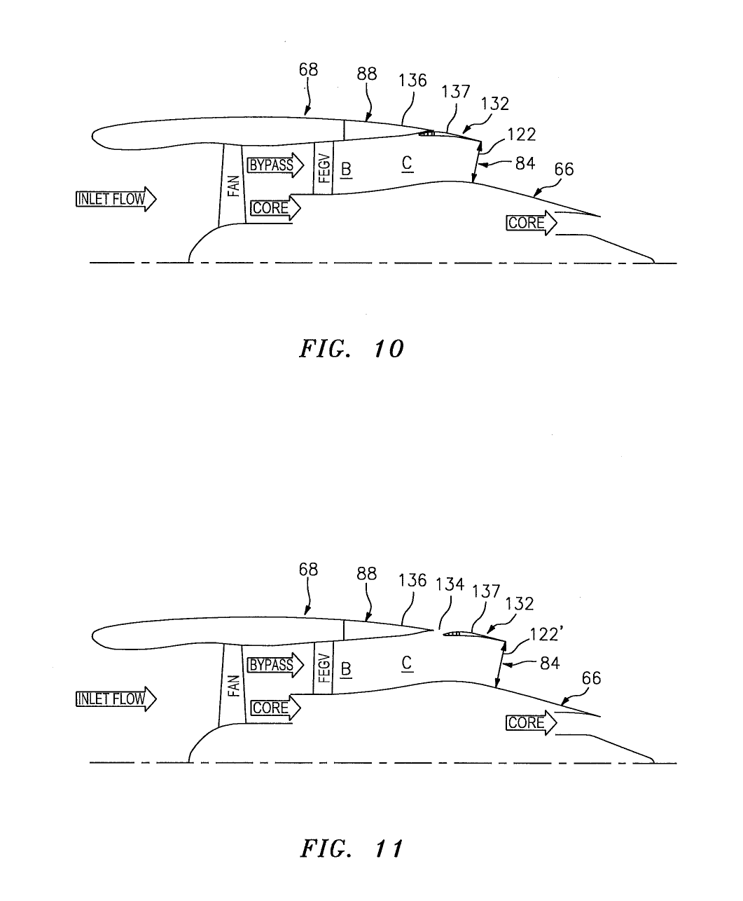

FIG. 8 illustrates an alternative embodiment thrust reverser 126 in a stowed position. FIG. 9 illustrates the thrust reverser 126 in a deployed position. In contrast to the thrust reverser 74 of FIGS. 5 to 7, the thrust reverser 126 is configured as a blockerless door thrust reverser. The thrust reverser 126, for example, includes a thrust reverser body 128 that is configured as (or with) the aft cowling 88. The thrust reverser body 128 includes a recess 130 that houses the cascades 110 when the thrust reverser 126 is in the stowed position. The thrust reverser 126 includes one or more actuators (not shown), which are adapted to axially translate the thrust reverser body 128 between the stowed position of FIG. 8 and the deployed position of FIG. 9. As the thrust reverser 74 deploys, the thrust reverser body 128 partially or fully obstructs the bypass flowpath B and diverts at least some (or substantially all) of the bypass air through the cascades 110 to provide the reverse engine thrust.

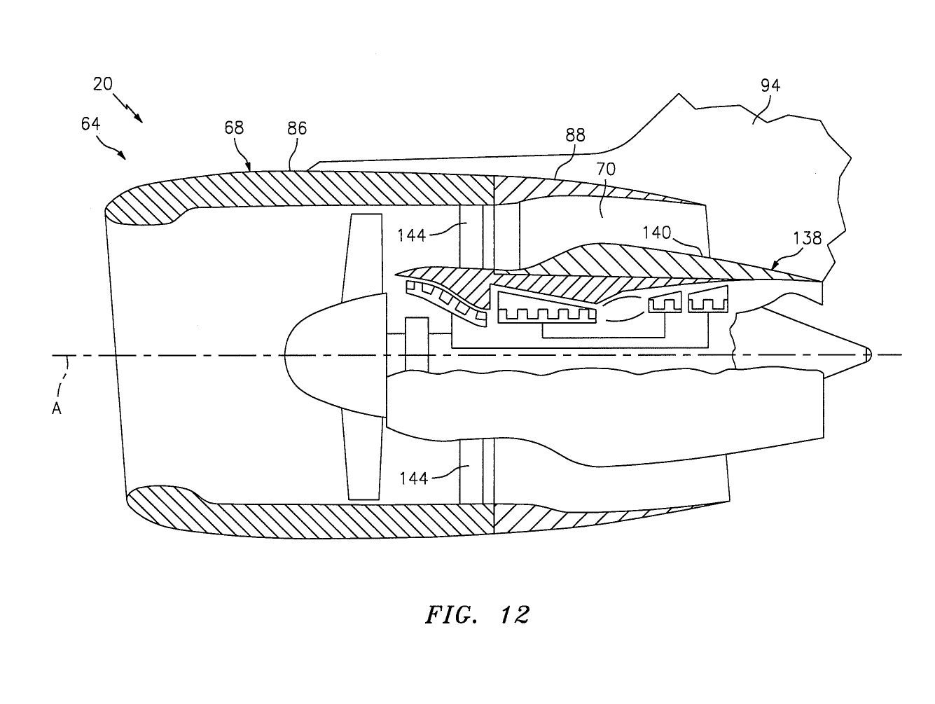

FIG. 10 illustrates an alternative embodiment variable area nozzle 132 in a stowed position. FIG. 11 illustrates the variable area nozzle 132 in a deployed position. In contrast to the variable area nozzle 76 of FIGS. 5 and 6, the variable area nozzle 132 is configured as a ported variable area nozzle. For example, the variable area nozzle 132 includes at least one auxiliary port 134. This auxiliary port 134 is defined between a forward portion 136 of the aft cowling 88 and a nozzle body 137 of the variable area nozzle 132 as the nozzle body 137 translates axially aftwards. A flow area through the auxiliary port 134 is added to the flow area of the bypass nozzle 84, thereby increasing an effective flow area of the variable area nozzle 132. The variable area nozzle 132 therefore may adjust the pressure drop across the bypass flowpath B while translating the nozzle body 137 over a smaller axial distance than that of the nozzle body 118 of FIGS. 5 and 6.

The engine casing 64 may also or alternatively include various thrust reversers and/or variable area nozzles other than those described above and illustrated in the drawings. For example, while the cascades 110 for the thrust reverses 74 and 126 of FIGS. 5 to 9 are axially fixed along the longitudinal axis A, one or more of these cascades 110 may alternatively axially translate with a respective thrust reverser body (e.g., the body 104 or 128). In another example, the thrust reverser body 104, 128 may include one or more circumferential segments that synchronously or independently translate or otherwise move between deployed and stowed positions. In still another example, the variable area nozzle 76, 132 may include one or more bodies (e.g., flaps) that may move radially (or axially and radially) to change the flow area of the bypass nozzle 84. The engine casing 64 therefore is not limited to including any particular types or configurations of thrust reversers or variable area nozzles. In addition, the engine casing 64 may be configured without a variable area nozzle; i.e., with a fixed area bypass nozzle.

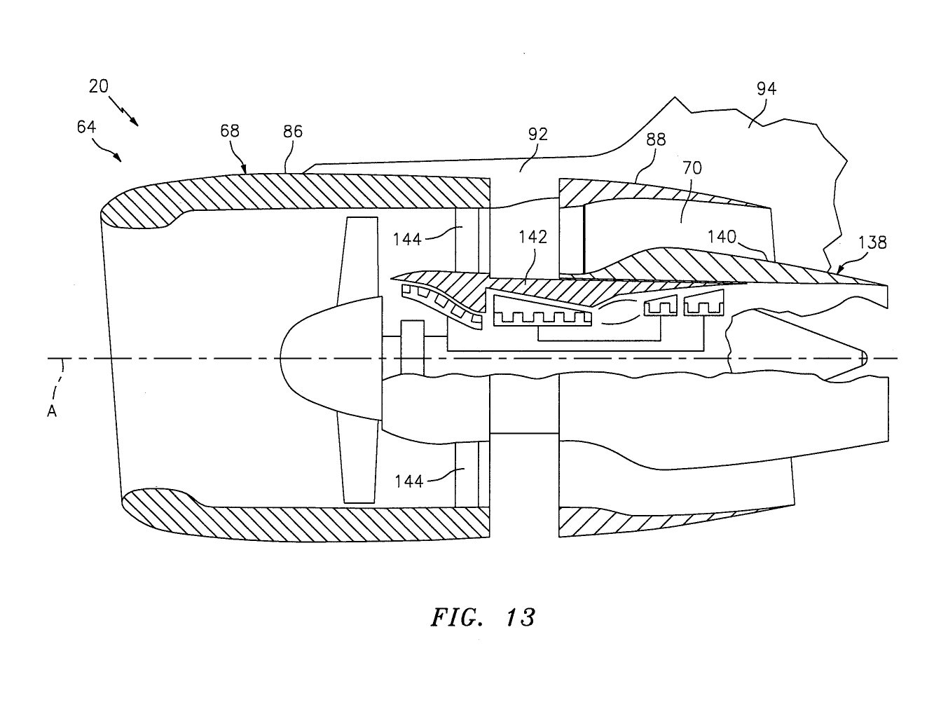

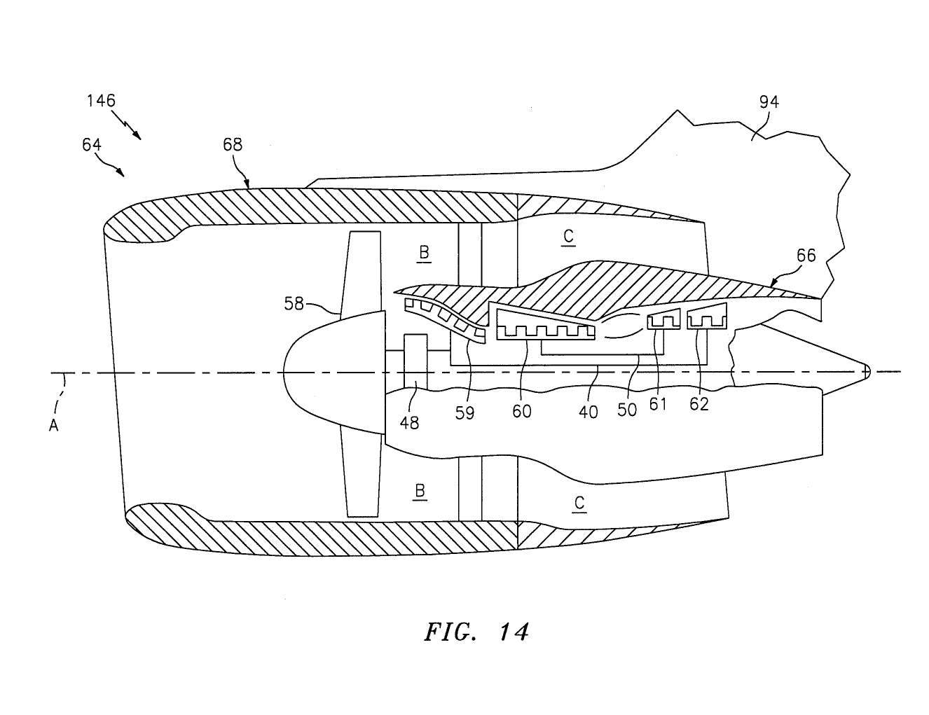

FIGS. 12 and 13 illustrate the engine casing 64 with an alternate embodiment core nacelle 138. In contrast to the core nacelle 66 of FIGS. 2 and 3, the core nacelle 138 includes an aft cowling 140 that is connected to the aft cowling 88 of the fan nacelle 68 by the bifurcation 72, and/or another structural member(s). In this manner, the aft cowling 140 may axially translate with the aft cowling 88 in order to provide access to an internal structural casing 142 for the engine core.

The engine casing 64 may have various configurations other than those described above and illustrated in the drawings. In addition, the engine casing 64 may include various components other than those described above and illustrated in the drawings. The engine casing 64 may also or alternatively omit one or more of the components described above or illustrated in the drawings; e.g., fan exit guide vanes 144. The present invention therefore is not limited to any particular engine casing components or configurations.

FIG. 14 is a partial sectional illustration of an alternate embodiment geared turbofan engine 146. In contrast to the engine 20 of FIG. 2, the fan rotor 58 and the LPC rotor 59 of the engine 146 are connected to the geared architecture 48, which is connected to and driven by the LPT rotor 62 through the inner shaft 40. The present invention, however, is not limited to any particular turbine engine configuration. For example, although the engines described above and illustrated in the drawings include a low speed spool (e.g., the rotors 59 and 62 and the shaft 40) and a high speed spool (e.g., the rotors 60 and 61 and the shaft 50), the engine casing 64 may be configured for a geared turbine engine with a single spool (e.g., no high speed spool) or more than two spools (e.g., low, mid and high speed spools, etc.).

The terms “forward”, “aft”, “inner” and “outer” are used to orientate the components of the engine casing 64 described above relative to the engine 20, 146 and the longitudinal axis A. A person of skill in the art will recognize, however, the engine casing components may be utilized in other orientations than those described above. The present invention therefore is not limited to any particular spatial orientations.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined within any one of the aspects and remain within the scope of the invention. Accordingly, the present invention is not to be restricted except in light of the attached claims and their equivalents.

What is claimed is:

1. A geared turbofan engine, comprising:
a first rotor, a second rotor and a gear train arranged along an axis within a casing;
the first rotor connected to and driven by the second rotor through the gear train;
the casing including a nozzle, a bifurcation, a thrust reverser and a flowpath; and
the flowpath extending axially to the nozzle and circumferentially between opposing surfaces of the bifurcation.

2. The engine of claim 1, wherein the thrust reverser has a flow area that is greater than a flow area of the nozzle.

3. The engine of claim 2, wherein the flow area of the thrust reverser is greater than or equal to about one hundred and ten percent of the flow area of the nozzle.

4. The engine of claim 1, further comprising a plurality of engine sections that provide forward engine thrust, wherein
a first of the engine sections includes the first rotor;
a second of the engine sections includes the second rotor; and
the thrust reverser provides reverse engine thrust that is greater than or equal to about one fifth of the forward engine thrust.

5. The engine of claim 1, wherein
the first rotor is configured as a fan rotor; and
the second rotor is configured as a turbine rotor.

6. The engine of claim 1, wherein
the first rotor is configured as a compressor rotor; and
the second rotor is configured as a turbine rotor.

7. The engine of claim 1, wherein the gear train comprises an epicyclic transmission.

8. The engine of claim 1, wherein
the casing further includes a core nacelle and a fan nacelle; and
the flowpath extends radially between an outer surface of the core nacelle and an inner surface of the fan nacelle.

9. The engine of claim 8, wherein the fan nacelle includes an aft cowling that axially translates along a support structure circumferentially aligned with the bifurcation.

10. The engine of claim 9, wherein the core nacelle includes an aft cowling that axially translates with the aft cowling of the fan nacelle.

11. The engine of claim 1, wherein the flowpath extends more than about 5.6 radians around the axis between the opposing surfaces of the bifurcation.

12. The engine of claim 1, wherein the thrust reverser includes a plurality of turning vanes arranged within an axially fixed cascade.

13. The engine of claim 1, wherein the thrust reverser includes a plurality of turning vanes arranged within a cascade that translates along the axis.

14. The engine of claim 1, wherein the thrust reverser includes a cascade and a blocker door that pivots into the flowpath and diverts gas through the cascade.

15. The engine of claim 1, wherein the thrust reverser includes a cascade and a thrust reverser body that translates along the axis to at least partially obstruct the flowpath and divert gas through the cascade.

16. The engine of claim 1, wherein the casing includes a body that defines the nozzle and that moves one or more of axially and radially to change a flow area of the nozzle.

17. A geared turbine engine, comprising:
a gear train connected to a first rotor and a second rotor along an axis; and
a casing housing the gear train, the first rotor and the second rotor;
the casing including a nozzle, an O-duct and a thrust reverser with a flow area that is greater than a flow area of the nozzle; and
the O-duct including an aft cowling that translates along the axis.

18. The engine of claim 17, wherein
the O-duct includes a nozzle, a bifurcation and a flowpath; and
the flowpath extends axially to the nozzle and circumferentially between opposing surfaces of the bifurcation.

19. A turbine engine system, comprising:
an engine support structure; and
a geared turbofan engine including an axis and a casing that is connected to the engine support structure;
the casing including a nozzle, a bifurcation, a thrust reverser and a bypass flowpath;
the thrust reverser having a flow area that is greater than a flow area of the nozzle; and
the bypass flowpath extending axially to the nozzle, and circumferentially between opposing surfaces of the bifurcation.

20. The system of claim 19, wherein
the geared turbofan engine includes a first rotor, a second rotor and a gear train that are arranged along the axis within the casing; and
the first rotor is connected to and driven by the second rotor through the gear train.
